(19) United States
(12) Patent Application Publication
(10) Pub. No.: US 2007/0278463 A1
(43) Pub. Date: Dec. 6, 2007

(54) Flame-Retardant Mixture for Lignocellulose Composites

(75) Inventors: Manfred Ratzsch, Altenberg Bei Linz (AT); Irmgard Bergmann, Linz (AT); Uwe Muller, Lufftenberg (AT); Michael Roth, Neuhofen (AT)

Correspondence Address: THE WEBB LAW FIRM, P.C., 700 KOPPERS BUILDING, 436 SEVENTH AVENUE, PITTSBURGH, PA, 15219, US

(73) Assignee: AMI AGROLINZ MELAMINE INTERNATIONAL GMBH, LINZ (AT)

(21) Appl. No.: 10/582,816

(22) PCT Filed: Dec. 17, 2004
(86) PCT No.: PCT/EP04/14748

§ 371 Date: Mar. 15, 2007

(30) Foreign Application Priority Data
Dec. 19, 2003 (DE) 103 61 878.3

(51) Int. Cl. C09K 21/00

(52) U.S. Cl. 252/607

(57) ABSTRACT

The invention relates to a flame-retardant mixture for lignocellulose composites having from 60 to 90% by mass of particulate or fibrous lignocellulose materials and from 40 to 10% by mass of a flame retardant concentrate immobilized on or in the particulate or fibrous lignocellulose materials as carriers. The flame retardants are boric acids or the salts thereof. Also, melamine resins and optionally synergistic agents and further additives may be present. The preparation of the flame-retardant mixture can be effected by a liquid impregnation process, a melt impregnation process and a liquid impregnation/solids mixing process. In the form of flame-retardant semifinished products and molding materials, the lignocellulose composites have high resistance to insect infestation, fungal infestation and mold infestation and high resistance to washing out of the flame-retardant mixture and are preferably suitable for applications in outdoor use in the building and leisure sector.

The invention relates to a flame-retardant mixture, in particular a flame-retardant mixture for lignocellulose composites, processes for the preparation thereof, molding materials for the production of flameproofed lignocellulose composites and the use thereof.

The use of boric acid and salts thereof (US 2002 011 593 A; GB 2 208 150 A1, WO 99/13022 A1, U.S. Pat. No. 6,306,317 A) and of melamine resins (PL 175 517 A) for providing wood with flame-retardant treatment is known. The fact that the flame-retardant can be partly washed out on contact with water is disadvantageous.

The use of formaldehyde resins, such as urea-formaldehyde resins or melamine-formaldehyde resins, in combination with glass fibers as carrier material for the flame-retardant treatment of polyolefins, such as polyethylene or ethylene-vinyl acetate copolymers (EP 0 219 024 A2) or polybutylene terephthalate (JP 2000 80 253 A) is furthermore known. Flame-retardant mixtures comprising phosphates and aminoplasts, which are applied to polypropylene fibers as carrier material, are described in DE 23 14 996 A1. Flame-retardant materials comprising aromatic polyamide fibers (EP 1 253 236 A1, U.S. Pat. No. 4,162,275 A) or polyester fibers (DE 21 28 691 A1), which are impregnated with crosslinkable melamine resins, are likewise known. Sheet silicates (JP 09 227 119 A, U.S. Pat. No. 5,853,886 A), talc (CA 2 000 472 A) and clay (U.S. Pat. No. 3,912,532 A) are likewise described as carrier material for fixing melamine resins. However, owing to the limited compatibility of the carrier material with lignocellulose materials, these carrier-fixed melamine resins are unsuitable as flame retardants for lignocellulose composites.

It is the object of the present invention to provide a flame-retardant mixture for lignocellulose composites which has high resistance to being washed out of the flame retardant on contact with water and provides reliable flame retardance in lignocellulose composites.

The object of the invention was achieved by a flame-retardant mixture for lignocellulose composites, the flame-retardant mixture containing, according to the invention, from 60 to 90% by mass of particulate and/or fibrous lignocellulose materials and from 40 to 10% by mass of a flame-retardant concentrate immobilized on the particulate and/or fibrous lignocellulose materials as carriers and comprising from 16 to 60% by mass of flame retardants of the type consisting of boric acids and/or the salts thereof and from 16 to 75% by mass of melamine resins, and the flame retardants being present chemically coupled to the melamine resins, and the flame retardant concentrates being present immobilized on and/or in the carrier substance of the particulate and/or fibrous lignocellulose materials as carriers.

Advantageously, the flame-retardant concentrate immobilized on the particulate and/or fibrous lignocellulose materials as carriers and comprising from 16 to 60% by mass of flame retardants of the type consisting of boric acids and/or the salts thereof and from 16% to 75% by mass of melamine resins additionally comprises up to 50% by mass of synergistic agents and/or 0 to 25% by mass of further additives.

The term “immobilized on the carrier” is to be understood as meaning the flame-retardant concentrates are immobilized on and/or in the lignocellulose carrier substance by the final curing of the melamine resins.

The particulate and/or fibrous lignocellulose material in the flame-retardant mixture are preferably chips, fibers and/or granular particles of softwoods and/or hardwoods, regenerated cellulose fibers, paper fibers, cotton fibers and/or bast fibers of flax, hemp, jute, ramie, sisal or kenaf. The particulate lignocellulose materials preferably have an average diameter of from 0.05 to 2 mm. Fibrous lignocellulose materials preferably have an average diameter of from 0.02 to 2 mm and an average fiber length of from 3 to 35 mm.

Examples of the melamine resins present in the flame-retardant mixture are polycondensates of melamine derivatives and C₁-C₁₀-aldehydes having a molar ratio of melamine or melamine derivative/C₁-C₁₀-aldehyde of from 1:1 to 1:6 and partial etherification products thereof with C₁-C₁₀-alcohols, the melamine derivatives preferably being ammeline, ammelide, acetoguanamine, caprinoguanamine and/or butyroguanamine, and the C₁-C₁₀-aldehydes preferably being formaldehyde, acetaldehyde, trimethylolacetaldehyde, furfural, glyoxal and/or glutaraldehyde. The melamine resin may also contain from 0.1 to 10% by mass, based on the sum of melamine and melamine derivatives, of urea.

The melamine resins present in the flame-retardant mixture are preferably polycondensates partly or completely etherified with C₁-C₁₈-monoalcohols, dialcohols and/or polyalcohols comprising melamine and C₁-C₁₈-aldehydes, particularly preferably comprising melamine and formaldehyde.

The melamine resins are particularly preferably relatively high molecular weight melamine resin ethers having number average molar masses of from 500 to 50 000.

The flame retardants present in the flame-retardant mixture and of the type consisting of boric acids and/or the salts thereof are preferably boric acid, metaboric acid, sodium tetraborate, sodium octaborate and/or ammonium pentaborate, the molar B₂O₃:Na₂O ratio being from 1:0 to 2:1.

The synergistic agents present in the flame-retardant mixture are preferably urea, melamine, melamine cyanurate, unetherified melamine resin precondensates, partly etherified melamine resin precondensates, cyanuric acid and/or phosphorous salts of the type consisting of sodium phosphates, monoammonium phosphates and/or ammonium polyphosphates, the proportion of the phosphorus salts being from 0 to 60% by mass, based on the overall sum of the synergistic agents. For reducing the washing out and for better compatibility with the other components the phosphorus salts are preferably used in the form encapsulated in melamine resin.

The further additives present in the flame-retardant mixture are preferably water repellants, impregnating auxiliaries and/or immobilizing agents for flame retardants.

Examples of water repellants which may be present in the flame-retardant mixture are organic silicon compounds of the type consisting of organosilanols, organosiloxanes, organosilanes, organoaminosilanes, polyorganosiloxanes terminated by terminal amino groups or terminal hydroxyl groups; surface-fluorinated SiO₂ nanoparticles, polytetrafluoroethylene nanoparticles and/or copolymers of ethylenically unsaturated C₄-C₂₀-dicarboxylic anhydrides, which copolymers contain imido groups.

Examples of impregnating auxiliaries which may be present in the flame-retardant mixture are methylcellulose, oxyethylcellulose and carboxymethylcellulose.

Examples of immobilizing agents for flame retardants which may be present in the flame-retardant mixtures are methylolated melamine and methylolated acetoguanamine.

Flame-retardant lignocellulose composites, in particular flame-retardant mixtures, can, according to the invention, be produced by liquid impregnation process, a melt impregnation process and a liquid impregnation/solids mixing process.

In the liquid impregnation process for the preparation of the flame-retardant mixture for lignocellulose composites, according to the invention from 60 to 90% by mass of particulate and/or fibrous lignocellulose materials and from 40 to 10% by mass of flame-retardant concentrate immobilized on the particulate and/or fibrous lignocellulose materials as carriers and comprising from 16 to 60% by mass of flame retardants of the type consisting of boric acids and/or the salts thereof, from 16 to 75% by mass of melamine resins, from 0 to 50% by mass of synergistic agents and from 0 to 25% by mass of further additives, the flame retardants of the type consisting of boric acids and/or the salts thereof being present chemically coupled to the melamine resins, and the flame-retardant concentrates being present immobilized on and/or in the carrier substance of the particulate and/or fibrous lignocellulose materials, by impregnating the particulate and/or fibrous lignocellulose materials with solutions or dispersions of flame retardants of the type consisting of boric acids and/or of the salts thereof at temperatures of from 20 to 90° C. by spraying or immersion and drying the particulate and/or fibrous lignocellulose materials impregnated with flame retardant concentrates at from 55 to 170° C. with partial curing of the melamine resins.

The preparation is preferably effected by a procedure in which the particulate and/or fibrous lignocellulose materials are sprayed or immersed
either with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass, which solutions contain the flame retardants of the type consisting of boric acids and/or the salts thereof and optionally synergistic agents in dissolved or dispersed form,
or with solutions or dispersions of the synergistic agents and subsequently with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass which contain the flame retardants of the type consisting of boric acids and/or the salts thereof in dissolved or dispersed form,
or with solutions or dispersions of the flame retardants of the type consisting of boric acids and/or the salts thereof and of the synergistic agents and subsequently with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass,
or with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass, and subsequently with solutions of the flame retardants of the type consisting of boric acids and/or the salts thereof,
or with solutions of the flame retardants of the type consisting of boric acids and/or the salts thereof, subsequently with solutions or dispersions of the synergistic agents and subsequently with solutions of melamine resins in water, C₁-C₈-alcohols or mixtures of from 10 to 90% by mass of water and from 90 to 10% by mass of C₁-C₈-alcohols having a solids content of melamine resins of from 10 to 60% by mass.

The further additives are added to the melamine resins, to the flame retardants of the type consisting of boric acids and/or of the salts thereof and/or to the synergistic agents, and the impregnation steps are effected with or without intermediate drying of the partly impregnated lignocellulose materials.

In the melt impregnation process for the preparation of the flame-retardant mixture for lignocellulose composites, according to the invention from 60 to 90% by mass of particulate and/or fibrous lignocellulose materials and from 40 to 10% by mass of a flame retardant concentrate immobilized on the particulate and/or fibrous lignocellulose materials as carriers, consisting of from 16 to 60% by mass of flame retardants of the type consisting of boric acids and/or the salts thereof, from 16 to 75% by mass of melamine resins, from 0 to 50% by mass of synergistic agents and from 0 to 25% by mass of other additives, flame retardants being present chemically coupled to the melamine resins, and the flame retardant concentrate being present immobilized on and/or in the carrier substance of the particulate and/or fibrous lignocellulose materials as carriers, are prepared by dispersing and partly dissolving flame retardants of the type consisting of boric acids and/or the salts thereof and optionally synergistic agents in melts of melamine resins at from 35 to 130° C. and subsequently dispersing the particulate and/or fibrous lignocellulose materials in the mixture or impregnating said materials with the melt of said mixtures, partial curing of the melamine resin taking place as a result of a temperature increase to 90 to 170° C., and the further additives being added to the melamine resins, to the flame retardants of the type consisting of boric acids and/or the salts thereof and/or to the synergistic agents.

In the liquid impregnation/solids mixing process for the preparation of the flame-retardant mixture for lignocellulose composites according to the invention from 60 to 90% by mass of particulate and/or fibrous lignocellulose materials and from 40 to 10% by mass of a flame-retardant concentrate immobilized on the particulate and/or fibrous lignocellulose materials as carriers and comprising from 16 to 60% by mass of flame retardants of the type consisting of boric acids and/or the salts thereof, from 16to 75% by mass of melamine resins, from 0 to 50% by mass of synergistic agents and from 0 to 25% by mass of further additives the flame retardants being present chemically coupled to the melamine resins, and the flame retardant concentrate being present immobilized on and/or in the carrier substance of the particulate and/or fibrous lignocellulose materials, are prepared by impregnating the particulate and/or fibrous lignocellulose materials with solutions or dispersions of flame retardants of the type consisting of boric acids and/or the salts thereof by spraying or immersion at temperatures of from 20 to 90° C. and drying the impregnated particulate and/or fibrous lignocellulose materials.

By spraying or immersion, the particulate and/or fibrous lignocellulose materials are preferably
either impregnated with solutions of melamine resins in water, C₁-C₈-alochols or mixtures of from 10 to 90% by mass of water and from 90 to 10% by mass of C₁-C₈-alcohols, having a solids content of melamine resins of from 10 to 60% by mass, and simultaneously or subsequently with solutions of the flame retardants of the type consisting of boric acids and/or the salts thereof at temperatures of from 20 to 90° C., the impregnated particulate and/or fibrous lignocellulose materials being dried at from 55 to 170° C. with partial curing of the melamine resins, and synergistic agents as solids being mixed with the impregnated particulate and/or fibrous lignocellulose materials,
or impregnated with solutions of the flame retardants of the type consisting of boric acids and/or the salts thereof at temperatures of from 20 to 90° C., the impregnated particulate and/or fibrous lignocellulose material being dried at from 55 to 170° C., and synergistic agents and melamine resins being mixed as solids with the impregnated particulate and/or fibrous lignocellulose materials
or impregnated with solutions and/or dispersions of the flame retardants of the type consisting of boric acids and/or the salts thereof and synergistic agents at temperatures of from 20 to 90° C., the impregnated particulate and/or fibrous lignocellulose materials being dried at from 55 to 170° C., and melamine resins being mixed as solid with the impregnated particulate and/or fibrous lignocellulose materials.

The further additives are added to the melamine resins, to the flame retardants of the type consisting of boric acids and/or the salts thereof and/or to the synergistic agents, and the impregnation steps are effected with intermediate drying or without intermediate drying of the partly impregnated lignocellulose materials.

The chemical coupling of the borate flame retardants to the melamine resins can be monitored during the preparation of the flame-retardant mixture by ATR-IR spectroscopy. With a strong decrease of typical borate bands, there is a shift of melamine resin bands in the IR spectrum.

In the process variants for the preparation of a flame-retardant mixture for lignocellulose composites, melamine resins preferably used are relatively high molecular weight melamine resin ethers having number-average molar masses of from 500 to 50 000. Relatively high molecular weight etherified melamine resin condensates which have been prepared by etherification of the hydroxymethylamino groups of the unetherified melamine resin condensates by C₁-C₈-alcohols and/or polyols of the type consisting of diols, triols and/or tetrols having molar masses of from 62 to 20 000 are preferred.

Molding materials for the production of flameproofed lignocellulose composites, comprising from 40 to 95% by mass of the flame-retardant mixture described above, from 60 to 5% by mass of thermosetting prepolymers of the type consisting of phenol resins, urea resins, melamine resins, guanidine resins cyanamide resins and/or aniline resins and from 0.1 to 10% by mass of processing auxiliaries and/or auxiliaries are likewise prepared by dry premixing of the components and optionally subsequent melt compounding at from 100 to 170° C. and granulation.

Examples of thermosetting prepolymers of the type consisting of phenol resins, which may be present in the molding materials for the production of the flameproofed lignocellulose composites, are phenol resins based on phenol, C₁-C₉-alkylphenols, hydroxyphenols and/or bisphenols.

Examples of thermosetting prepolymers of the type consisting of urea resins, which may be present in the molding materials for the production of the flameproofed lignocellulose composites, are, in addition to urea-formaldehyde resins, also cocondensates with phenols, acid amides or sulfonamides.

Examples of thermosetting prepolymers of the type consisting of melamine resins, which may be present in the molding materials for the production of the flameproofed lignocellulose composites, are condensates of melamine and C₁-C₁₀-aldehydes having a molar ratio of melamine or melamine derivative/C₁-C₁₀-aldehyde of from 1:1 to 1:6 and the partial etherification products thereof with C₁-C₁₀-alcohols.

Examples of thermosetting prepolymers of the type consisting of guanamine resins, which may be present in the molding materials for the production of the flameproofed lignocellulose composites, are resins which contain benzoguanamine, acetoguanamine, tetramethoxymethylbenzoguanamine, caprinoguanamine and/or butyroguanamine as the guanamine component.

Examples of thermosetting prepolymers of the type consisting of aniline resins, which may be present in the molding materials for the production of the flameproofed lignocellulose composites, are aniline resins which, in addition to aniline, may also contain toluidine and/or xylidines as aromatic diamines.

Suitable processing auxiliaries which may be present in the molding materials are lubricants of the type consisting of zinc stearate, calcium stearate and/or magnesium stearate, release agents of the type consisting of talc, alumina, sodium carbonate, calcium carbonate, silica and/or polytetrafluoroethylene powder and/or thermoplastic polymers as flow improvers, such as polycaprolactone or ethylene-vinyl acetate copolymer wax.

The molding materials may contain pigments, UV absorbers and/or free radical scavengers as auxiliaries.

Examples of suitable pigments which may be present in the molding materials according to the invention are iron oxide, isoindoline pigments containing ester groups, fluorescent anthracene dyes, carbazole dioxazine and delta-indanthrone blue pigment.

Examples of suitable UV absorbers which may be present in the molding materials according to the invention are 2-(2-hydroxy-3-tert-butyl-5-methylphenyl)benzotriazole, 2,4-dihydroxybenzophenone and sodium 3-(2H-benzotriazole-2-yl)-5-sec-butyl-4-hydroxybenzenesulfate.

Examples of suitable free radical scavengers which may be present in the molding materials according to the invention are bis[2,2,6,6-tetramethyl-1-(octyloxy)-4-piperidinyl sebacate, bis(2,2,6,6-tetramethyl-4-piperidinyl) sebacate, N,N′-(2-hydroxyphenyl)ethanediamide and N,N′-diformyl-N,N′-di-(1-oxyl radical-2,2,6,6-tetramethyl-4-piperidinyl)-1,6-hexanediamine.

Furthermore according to the invention are flameproofed lignocellulose composites produced by extrusion, injection molding or pressing of the molding materials described above at from 100 to 220° C. with simultaneous curing.

The lignocellulose composites can preferably be used as flame-retardant semifinished products and molding materials having high resistance to insect infestation, fungal infestation and mold infestation and having high resistance to washing out of the flame retardant for applications in outdoor use in the building and leisure sector.

The flameproofed lignocellulose composites according to the invention are poorly combustible. They decompose very slowly at high temperature and give off slightly combustible and toxic gases. Without an external flame, they do not continue to burn or scarcely continue to burn by themselves, the heat released during the thermal decomposition is small, they scarcely incandesce and glow. The flameproofed lignocellulose composites can be classified as flame-retardant (class B1) according to DIN 4102.

In the flameproofed lignocellulose composites according to the invention, the flame retardants have high resistance to water since they are protected from being washed out, and only about 20% by mass of flame retardants which are present in a form not immobilized on the carrier are slowly washed out. Consequently, permanent flame retardance is present in a moist or wet environment.

Owing to the content of boron compounds, the flameproofed lignocellulose composites are protected to a high degree from fungal and mold infestation. Since the boron compounds are protected from being washed out, the lignocellulose composites can be used in a moist or wet environment.

The invention is explained by the following examples:

### EXAMPLE 1

1.1 Preparation of the Flame-retardant Mixture by the Liquid Impregnation Process

840 g of spruce wood chips (particle size from 0.8 to 3 mm, residual moisture content 5% by mass) are heated to 95° C. in a high-speed mixer (capacity 10 l) at 500 rpm. 870 g of a solution of 40 g of melamine, 15 g of borax and 815 g of water, heated to 95° C. are sprayed onto the agitated spruce wood particles in the course of 20 min through a nozzle. Thereafter, the temperature is increased to 120° C., dry air is blown in and the impregnated spruce wood particles are dried in the course of 90 min to a residual moisture content of 2.5% by mass.

After the spruce wood particles treated in the first impregnation step have been cooled to 40° C., 280 g of a solution of 80 g of a methyl-etherified melamine resin (average molar mass 700, molar melamine/formaldehyde ratio 1:3, free OH groups not detectable), 60 g of boric acid and 140 g of methanol and water (volume ratio 2:1) are sprayed onto the spruce wood particles in the second impregnation step in the course of 10 min through a nozzle.

Spruce wood particles impregnated with boric acid/borax as flame retardant, melamine resin and melamine as a synergistic agent are dried at 60° C. in a dry air stream with removal of water and methanol to a residual moisture content of 2% by mass, partial curing of the etherified melamine resin taking place.

ATR/IR investigations of the dry residue of the impregnating solution show chemical coupling of the boric acid to the methyl-etherified melamine resin, on the basis of the decrease of typical B—O—H bands, shifting of the B—O bands and decrease of the N—H bands in the methyl-etherified melamine resin.

1.2 Preparation of the Molding Materials and Processing of the Molding Materials to Give Lignocellulose Composites

1050 g of the flame-retardant mixture prepared in 1.1 are mixed with 250 g of a granulated melamine resin prepolymer (with methanol and oligocaprolactone, average molar mass 900, etherified melamine resin oligomer, average molar mass 5000, molar melamine/formaldehyde ratio 1:3, free OH groups not detectable, 10 mol % of the methyl groups are etherified with oligocaprolactone) and 100 g of processing auxiliary (mixture of 92 g of polycaprolactone, molar mass 38 000, and 8 g of zinc stearate), compounded in a Brabender laboratory extruder at 115° C. and granulated.

The molding materials prepared are molded at 165° C./50 bar to give 15 mm and 30 mm composite sheets measuring 150×150 mm.

1.3 Testing of the Lignocellulose Composite

Test specimens cut from composite sheet are tested for testing the fire behavior. After application of the test flame for 60 s, the test specimens do not continue to bum (self-extinguishing). The test specimens do not continue to incandesce after removal of the test flame. In contrast to composite test specimens in which the spruce chips were not treated by impregnation, the carbonization is substantially slowed down. The lignocellulose composite can be classified as B1 according to DIN 4102.

For testing the wash-out properties of the flame-retardant mixture, test specimens (15×15×15 mm) from the composite sheet are stored in 1000 ml of water at 25° C. with moderate stirring for extracting the boron compounds, samples are taken after from 24 to 240 hours and the boron content of the extraction solution is determined photometrically.

The extraction of the test specimens leads to the following results:

| | Extraction time (hours) | | | |
|---|---|---|---|---|
| | 24 | 48 | 120 | 240 |
| Amount of boron washed out, based on the | 11.2 | 16.0 | 19.4 | 20.1 |
| total content of the test specimen | | | | |
| (% by mass) | | | | |

About 20% by mass of the boron compounds are present in only weakly bound form in the composite and are dissolved out of the composite during long extraction times; about 80% by mass of the boron compounds are present in stable immobilized on from the carrier in the composite.

### EXAMPLE 2

Experimental procedure as in example 1, but 870 g of a solution of 40 g of melamine and 830 g of water, heated to 95° C. are sprayed on in the course of 20 min through a nozzle in the first impregnation step. In the second impregnation step, 280 g of a solution of 80 g of a methyl-etherified melamine resin (average molar mass 1200, molar melamine/formaldehyde ratio 1:3, free OH groups not detectable), 60 g of boric acid and 140 g of a mixture of methanol and water (volume ratio 2:1) are sprayed on in the course of 10 min through a nozzle.

The extraction of test specimens which were produced from the flame-retardant mixture prepared in example 2 and granulated melamine resin prepolymer leads to the following results:

| | Extraction time (hours) | | | |
|---|---|---|---|---|
| | 24 | 48 | 120 | 240 |
| Amount of boron washed out, based on the | 10.5 | 14.2 | 17.1 | 17.7 |
| total content of the test specimen | | | | |
| (% by mass) | | | | |

### EXAMPLE 3

Experimental procedure as in example 1, but 180 g of a solution of 40 g of urea and 15 g of borax in 125 g of water, heated to 95° C. are sprayed on in the course of 20 min through a nozzle in the first impregnation step. In the second impregnation step, 280 g of a solution of 80 g of a methyl-etherified melamine resin (average molar mass 1200, molar melamine/formaldehyde ratio 1:3, free OH groups not detectable), 60 g of boric acid and 140 g of a mixture of methanol and water (volume ratio 2:1) are sprayed on in the course of 10 min through a nozzle.

The extraction of test specimens which were produced from the flame-retardant mixture prepared in example 3 and granulated melamine resin prepolymer leads to the following results:

| | Extraction time (hours) | | | |
|---|---|---|---|---|
| | 24 | 48 | 120 | 240 |
| Amount of boron washed out, based on the | 14.1 | 19.0 | 22.9 | 23.7 |
| total content of the test specimen | | | | |
| (% by mass) | | | | |

### EXAMPLE 4

Experimental procedure as in example 1, but 140 g of a solution of 40 g of urea in 100 g of water, heated to 95° C. are sprayed on in the course of 20 min through a nozzle in the first impregnation step. In the second impregnation step, 280 g of a solution of 80 g of a methyl-etherified melamine resin (average molar mass 1200, molar melamine/formaldehyde ratio 1:3, free OH groups not detectable), 60 g of boric acid and 140 g of a mixture of methanol and water (volume ratio 2:1) are sprayed on in the course of 10 min through a nozzle.

The extraction of test specimens which were produced from the flame-retardant mixture prepared in example 4 and granulated melamine resin prepolymer leads to the following results:

| | Extraction time (hours) | | | |
|---|---|---|---|---|
| | 24 | 48 | 120 | 240 |
| Amount of boron washed out, based on the | 12.7 | 17.6 | 21.0 | 21.8 |
| total content of the test specimen | | | | |
| (% by mass) | | | | |

### EXAMPLE 5

5.1 Preparation of the Flameproofing Mixture by the Liquid Impregnation/solids Mixing Process

60 g of boric acid are dissolved in 280 g of a solution of 40 g of a methyl-etherified melamine resin (average molar mass 1500, molar melamine/formaldehyde ratio 1:2.5, free OH groups not detectable), 40 g of hexamethylmethylolmelamine and 200 g of a mixture of methanol and water (volume ratio 5:2) with heating at 45° C. The solution is sprayed in a high-speed mixer (capacity 10 l) at 55° C., and 450 rpm onto an agitated mixture of 770 g of pine wood chips (particle size from 0.4 to 2.5 mm, residual moisture content 10% by mass) and 143 g of flax fibers (length from 1 to 15 mm, average diameter 0.07 mm, residual moisture content 10% by mass).

Thereafter, 30 g of melamine resin-encapsulated ammonium polyphosphate (average particle size 20 μm) are metered into the mixer, the temperature is increased to 75° C., dry air is blown in and the impregnated lignocellulose particles are dried to a residual moisture content of 2.0% by mass, partial curing of the etherified melamine resin taking place.

ATR/IR investigations of the dry residue of the impregnating solution show chemical coupling of the boric acid to the methyl-etherified melamine resin, on the basis of the decrease of typical B—O—H bands, shifting of the B—O bands and decrease of the N—H bands in the methyl-etherified melamine resin.

5.2 Preparation of the Molding Materials and Processing of the Molding Materials to Give Lignocellulose Composites

1075 g of the flame-retardant mixture prepared in 5.1 are mixed with 350 g of a granulated melamine resin prepolymer (melamine resin oligomer etherified with methanol and polyethylene glycol having an average molar mass of 1000, average molar mass 5000, molar melamine/formaldehyde ratio 1:3.5, free OH groups not detectable, 18 mol % of the methylol groups are etherified with polyethylene glycol) and 75 g of processing auxiliaries (mixture of 57 g of polycaprolactone, molar mass 38 000, and 18 g of polycaprolactone, molar mass 2000), compounded in a Brabender laboratory extruder at 110° C. and granulated. The prepared molding materials are molded at 165° C./60 bar to give 15 mm composite sheets measuring 150×150 mm.

5.3 Testing of the Lignocellulose Composite

For testing of the wash-out properties of the flame-retardant mixture, test specimens (15×15×15 mm) of the composite sheet are stored in 1000 ml of water at 25° C. with moderate stirring for extracting the boron compounds, samples are taken after from 24 to 240 hours and the boron content of the extraction solution is determined photometrically.

The extraction of the test specimens leads to the following results:

| | Extraction time (hours) | | | |
|---|---|---|---|---|
| | 24 | 48 | 120 | 240 |
| Amount of boron washed out, based on the | 10.8 | 14.4 | 17.1 | 17.6 |
| total content of the test specimen | | | | |
| (% by mass) | | | | |

### EXAMPLE 6

6.1 Preparation of the Flame-retardant Mixture by Liquid Impregnation Process

900 g of spruce wood chips (particle size from 0.8 to 3 mm, residual moisture content 10% by mass) are heated to 70° C. in a high-speed mixer (capacity 10 l) at 700 rpm. A solution of 45 g of disodium octaborate, 30 g of urea, and 10 g of boric acid in 160 g of water is sprayed onto the agitated spruce wood particles at 70° C. Immediately thereafter, 205 g of a solution heated to 70° C. and comprising 90 g of a methyl-etherified melamine resin (average molar mass 1200 molar melamine/formaldehyde ratio 1:3, free OH groups not detectable) in 115 g of a mixture of methanol and water (volume ratio 2;1) are sprayed on, and the impregnated spruce wood chips are dried at 110° C. in a dry air stream with removal of water and methanol to a residual moisture content of 2% by mass, partial curing of the etherified melamine resin taking place.

ATR/IR investigations of the dry residue of the impregnating solution show chemical coupling of the boric acid to the methyl-etherified melamine resin, on the basis of the decrease of typical B—O—H bands, shifting of the B—O bands and decrease of the N—H bands in the methyl-etherified melamine resin.

6.2 Preparation of the Molding Materials and Processing of the Molding Materials to Give Lignocellulose Composites

1090 g of the flame-retardant mixture prepared in 7.1 are mixed with 320 g of a granulated melamine resin prepolymer (melamine resin oligomer etherified with methanol and trifunctional polycaprolactone having an average molar mass of 2000, average molar mass 6500, melamine/fonmaldehyde ratio 1:3.5, free OH groups not detectable, 15 mol % of the methylol groups are etherified with polycaprolactone), compounded in a Brabender laboratory extruder at 110° C. and granulated.

The prepared molding materials are molded at 170° C./65 bar to give 15 mm composite sheets measuring 150×150 mm.

6.3 Testing of the Lignocellulose Composite

For-testing of the wash-out properties of the flame-retardant mixture, test specimens (15×15×15 mm) of the composite sheet are stored in 1000 ml of water at 25° C. with moderate stirring for extracting the boron compounds, samples are taken after from 24 to 240 hours and the boron content of the extraction solution is determined photometrically.

The extraction of the test specimens leads to the following results:

| | Extraction time (hours) | | | |
|---|---|---|---|---|
| | 24 | 48 | 120 | 240 |
| Amount of boron washed out, based on the | 14.2 | 18.5 | 22.8 | 23.7 |
| total content of the test specimen | | | | |
| (% by mass) | | | | |

### EXAMPLE 7

7.1 Preparation of the Flame-retardant Mixture by the Liquid Impregnation/solids Mixing Process

60 g of boric acid, 6 g of borax decahydrate and 75 g of a methyl-etherified melamine resin (average molar mass 1500, molar melamine/formaldehyde ratio 1:2.5, free OH groups not detectable) are dissolved in 250 g of a mixture of methanol and water (volume ratio 1:2) with heating at 60° C. The solution is sprayed in a high-speed mixer (capacity 10 l) at 60° C. and 600 rpm onto an agitated mixture of 800 g of pine wood chips (particle size from 0.4 to 2.5 mm, residual moisture content 10% by mass) and 110 g of hemp fibers (length from 1.5 to 18 mm, average diameter 0.06 mm, residual moisture content 10% by mass) in the course of 15 min.

Thereafter, 35 g of melamine cyanurate (average particle size 15 μm) are metered into the mixer at 1200 rpm, the temperature is increased to 90° C., dry air is blown in and the impregnated lignocellulose particles are dried to a residual moisture content of 2.0% by mass, partial curing of the etherified melamine resin taking place.

ATR/IR investigations of the dry residue of the impregnating solution show chemical coupling of the boric acid to the methyl-etherified melamine resin, on the basis of the decrease of typical B—O—H bands, shifting of the B—O bands and decrease of the N—H bands in the methyl-etherified melamine resin.

7.2 Preparation of the Molding Materials and Processing of the Molding Materials to Give Lignocellulose Composites

1085 g of the flame-retardant mixture prepared in 7.1 are mixed with 220 g of a granulated melamine resin prepolymer (melamine resin oligomer etherified with methanol and triethylene glycol, average molar mass 3000, molar melamine/formaldehyde ratio 1:3, free OH groups not detectable, 7 mol % of the methylol groups are etherified with triethylene glycol) and 75 g of processing auxiliaries (ethylene vinyl acetate copolymer wax, weight-average molar mass 6500, vinyl acetate content 16% by mass), compounded in a Brabender laboratory extruder at 110° C. and granulated.

The prepared molding materials are molded at 165° C./60 bar to give 15 mm composite sheets measuring 150×150 mm.

7.3 Testing of the Lignocellulose Composite

For testing of the wash-out properties of the flame-retardant mixture, test specimens (15×15×15 mm) of the composite sheet are stored in 1000 ml of water at 25° C. with moderate stirring for extracting the boron compounds, samples are taken after from 24 to 240 hours and the boron content of the extraction solution is determined photometrically.

The extraction of the test specimens leads to the following results:

| | Extraction time (hours) | | | |
|---|---|---|---|---|
| | 24 | 48 | 120 | 240 |
| Amount of boron washed out, based on the | 12.8 | 17.8 | 21.8 | 22.4 |
| total content of the test specimen | | | | |
| (% by mass) | | | | |

### EXAMPLE 8

8.1 Preparation of the Flame-retardant Mixture by the Melt Impregnation Process

85 g of a granulated melamine resin prepolymer (melamine resin oligomer etherified with methanol and bis(hydroxyethyl) terephthalate, average molar mass 4500, molar melamine/formaldehyde ratio 1:3.2, free OH groups not detectable, 22 mol % of the methylol groups are etherified with bis(hydroxyethyl) terephthalate) are melted at 85° C. in a Brabender kneader (capacity 500 ml), and 25 g of boric acid, 12 g of borax and 6 g of melamine are metered into the melt and homogenized with the melamine resin melt for 10 min. Thereafter, 260 g of oak wood particles (average diameter 0.35 mm, residual moisture content 1.0% by mass) are metered into the melt and kneaded with the melt for 8 min at 85° C. for impregnation. Increasing the temperature to 105° C. and kneading for 4 min results in partial curing of the etherified melamine resin oligomer. The flame-retardant mixture is discharged and, after solidification, is milled in a cutting mill.

8.2 Preparation of the Molding Materials and Processing of the Molding Materials to Give Lignocellulose Composites

400 g of the flame-retardant mixture prepared in 8.1 are mixed with 100 g of a milled phenol novolak (average molar mass 720, molar phenol/formaldehyde ratio 1:0.68) and 25 g of polycaprolactone (molar mass 38 000), compounded in a Brabender laboratory extruder at 120° C. and granulated. The prepared molding materials are molded at 180° C./50 bar to give 15 mm composite sheets measuring 150×150 mm.

8.3 Testing of the Lignocellulose Composite

For testing of the wash-out properties of the flame-retardant mixture, test specimens (15×15×15 mm) of the composite sheet are stored in 1000 ml of water at 25° C. with moderate stirring for extracting the boron compounds, samples are taken after from 24 to 240 hours and the boron content of the extraction solution is determined photometrically.

The extraction of the test specimens leads to the following results:

| | Extraction time (hours) | | | |
|---|---|---|---|---|
| | 24 | 48 | 120 | 240 |
| Amount of boron washed out, based on the | 12.8 | 15.9 | 21.8 | 22.6 |
| total content of the test specimen | | | | |
| (% by mass) | | | | |

1-27. (canceled)

28. A flame-retardant mixture for lignocellulose composites, comprising:
from 60 to 90% by mass of at least one of particulate and fibrous lignocellulose materials, and
from 40 to 10% by mass of a flame-retardant concentrate immobilized on or in the particulate or fibrous lignocellulose materials as carriers, having
from 16 to 60% by mass of flame retardants of the type consisting of boric acids or the salts thereof or both, and
from 16 to 75% by mass of melamine resins, the melamine resins being polycondensates partly or completely etherified with C₁-C₁₈-monoalcohols, dialcohols or polyalcohols of melamine and C₁-C₈-aldehydes, and wherein the flame retardants of the type consisting of boric acid or the salts thereof are chemically coupled to the melamine resins, and the flame retardant concentrates are immobilized on or in the carrier substance of the particulate or fibrous lignocellulose materials as carriers.

29. The flame-retardant mixture as claimed in claim 28, wherein the flame retardant concentrate immobilized on or in the particulate or fibrous lignocellulose materials as carriers furthermore comprises up to 50% by mass of synergistic agents or 25% by mass of further additives or both.

30. The flame-retardant mixture as claimed in claim 28, wherein the particulate and fibrous lignocellulose materials are chips, fibers or granular particles of softwoods or hardwoods, regenerated cellulose fibers, paper fibers, cotton fibers or bast fibers of flax, hemp, jute, ramie, sisal or kenaf.

31. The flame-retardant mixture as claimed in claim 28, wherein the melamine resins are polycondensates partly or completely etherified with at least one of C₁-C₁₈-monoalcohols, dialcohols and polyalcohols of melamine and formaldehyde.

32. The flame-retardant mixture as claimed in claim 28, wherein the melamine resins are relatively high molecular weight melamine resin ethers having a number of average molar masses of from 500 to 50,000.

33. The flame-retardant mixture as claimed in claim 28, wherein the flame retardants of the type consisting of boric acids or the salts thereof are selected from the group consisting of boric acid, metaboric acid, sodium tetraborate, sodium octaborate and ammonium pentaborate, and wherein the molar B₂O₃:Na₂O ratio is from 1:0 to 2:1.

34. The flame-retardant mixture as claimed in claim 29, wherein the synergistic agents are selected from the group consisting of urea, melamine, melamine cyanurate, unetherified melamine resin precondensates, partly etherified melamine resin precondensates, cyanuric acid and phosphorus salts, and wherein the phosphorus salts are at least one of sodium phosphates, monoammonium phosphates or ammonium polyphosphates, and wherein the proportion of the phosphorus salts is from 0 to 60% by mass based on the overall sum of the synergistic agents.

35. The flame-retardant mixture as claimed in claim 29, wherein the further additives are at least one of water repellants, impregnating auxiliaries and immobilizing auxiliaries for flame retardants.

36. A process for the production of a flame-retardant lignocellulose composite comprising:
from 60 to 90% by mass of at least one of particulate and fibrous lignocellulose materials, and
from 40 to 10% by mass of a flame-retardant concentrate immobilized on or in the particulate or fibrous lignocellulose materials as carriers, having
from 16 to 60% by mass of flame retardants of the type consisting of boric acids or the salts thereof or both, and
from 16 to 75% by mass of melamine resins, the melamine resins being polycondensates partly or completely etherified with C₁-C₁₈-monoalcohols, dialcohols or polyalcohols of melamine and C₁-C₈-aldehydes, and wherein the flame retardants of the type consisting of boric acid or the salts thereof are chemically coupled to the melamine resins, and the flame retardant concentrates are immobilized on or in the carrier substance of the particulate or fibrous lignocellulose materials as carriers, wherein the composite is produced by a liquid impregnation process in which the particulate or fibrous lignocellulose materials are impregnated with solutions or dispersions of flame retardants of the type consisting of boric acids or the salts thereof at temperatures of from 20 to 90° C. by spraying or immersion, and the particulate or fibrous lignocellulose materials impregnated with flame retardant concentrates are dried at from 55 to 170° C. with partial curing of the melamine resins.

37. The process as claimed in claim 36, wherein the particulate or fibrous lignocellulose materials are impregnated with solutions of melamine resins in water, C₁-C₈-alcohols or mixtures of from 10 to 90% by mass of water and from 90 to 10% by mass of from C₁-C₈-alcohols, having a solids content of melamine resins of from 10 to 60% by mass, which solutions contain the flame retardants of the type consisting of boric acids or the salts thereof or both and synergistic agents in dissolved or dispersed form.

38. The process as claimed in claim 36, wherein the particulate or fibrous lignocellulose materials are impregnated with solutions or dispersions of the synergistic agents and subsequently with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass, which solutions contain the flame retardants of the type consisting of boric acids or the salts thereof or both in dissolved or dispersed form.

39. The process as claimed in claim 36, wherein the particulate or fibrous lignocellulose materials are impregnated with solutions or dispersions of the flame retardants and of the synergistic agents and subsequently with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass.

40. The process as claimed in claim 36, wherein the particulate or fibrous lignocellulose materials are impregnated with solutions of melamine resins in water, C₁-C₈-alcohols or mixtures of from 10 to 90% by mass of water and from 90 to 10% by mass of from C₁-C₈-alcohols, having a solids content of melamine resins of from 10 to 60% by mass, which solutions contain the flame retardants of the type consisting of boric acids or the salts thereof or both in dissolved or dispersed form.

41. The process as claimed in claim 36, wherein the particulate or fibrous lignocellulose materials are impregnated with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass, and subsequently with solutions of the flame retardants of the type consisting of boric acids or the salts thereof or both.

42. The process as claimed in claim 36, wherein the particulate or fibrous lignocellulose materials are impregnated with solutions of the flame retardants of the type consisting of boric acids or the salts thereof or both, subsequently with solutions or dispersions of the synergistic agents and subsequently with solutions of melamine resins in water, C₁-C₈-alcohols or mixtures of from 10 to 90% by mass of water and from 90 to 10% by mass of C₁-C₈-alcohols, having a solids content of melamine resins of from 10 to 60% by mass.

43. The process as claimed in claim 36, wherein further additives are added to the melamine resins, to the flame retardants of the type consisting of boric acids or the salts thereof or to the synergistic agents.

44. A process for the production of a flame-retardant lignocellulose composite comprising:
from 60 to 90% by mass of at least one of particulate and fibrous lignocellulose materials, and
from 40 to 10% by mass of a flame-retardant concentrate immobilized on or in the particulate or fibrous lignocellulose materials as carriers, having
from 16 to 60% by mass of flame retardants of the type consisting of boric acids or the salts thereof or both, and
from 16 to 75% by mass of melamine resins, the melamine resins being polycondensates partly or completely etherified with C₁-C₁₈-monoalcohols, dialcohols or polyalcohols of melamine and C₁-C₈-aldehydes, and wherein the flame retardants of the type consisting of boric acid or the salts thereof are chemically coupled to the melamine resins, and the flame retardant concentrates are immobilized on or in the carrier substance of the particulate or fibrous lignocellulose materials as carriers, wherein the flame-retardant mixture is prepared by a melt impregnation process in which flame retardants are dispersed and partly dissolved in melts of melamine resins at from 35 to 130° C. and subsequently the particulate or fibrous lignocellulose materials are dispersed in the mixtures and impregnated with the melt of said mixtures, partial curing of the melamine resin taking place as a result of a temperature increase to 90 to 170° C. and further additives being added to the melamine resins, to the flame retardants of the type consisting of boric acids or the salts thereof or both or to the synergistic agents.

45. The process as claimed in claim 44, wherein, in the melt impregnation process, in addition to the flame retardants of the type consisting of boric acids or the salts thereof or both, synergistic agents are dispersed and partly dissolved in the melts of melamine resins at from 35 to 130° C.

46. A process using a flame-retardant mixture comprising:
from 60 to 90% by mass of at least one of particulate and fibrous lignocellulose materials, and
from 40 to 10% by mass of a flame-retardant concentrate immobilized on or in the particulate or fibrous lignocellulose materials as carriers, having
from 16 to 60% by mass of flame retardants of the type consisting of boric acids or the salts thereof or both, and
from 16 to 75% by mass of melamine resins, the melamine resins being polycondensates partly or completely etherified with C₁-C₁₈-monoalcohols, dialcohols or polyalcohols of melamine and C₁-C₈-aldehydes, and wherein the flame retardants of the type consisting of boric acid or the salts thereof are chemically coupled to the melamine resins, and the flame retardant concentrates are immobilized on or in the carrier substance of the particulate or fibrous lignocellulose materials as carriers, wherein the composite is produced by a liquid impregnation/solids mixing process in which the particulate or fibrous lignocellulose materials are impregnated with solutions or dispersions of flame retardants of the type consisting of boric acids or the salts thereof or both at temperatures of from 20 to 90° C. by spraying or immersion, and the impregnated particulate or fibrous lignocellulose materials are dried.

47. The process as claimed in claim 46, wherein the particulate or fibrous lignocellulose materials are impregnated with solutions of melamine resins in water, C₁-C₈-alcohols or mixtures of from 10 to 90% by mass of water and from 90 to 10% by mass of C₁-C₈-alcohols, having a solids content of melamnine resins of from 10 to 60% by mass, and simultaneously or subsequently with solutions of the flame retardants of the type consisting of boric acids or the salts thereof or both at temperatures of from 20 to 90° C., the impregnated particulate or fibrous lignocellulose materials are dried at from 55 to 170° C. with partial curing of the melamine resins, and synergistic agents are mixed as solids with the impregnated particulate or fibrous lignocellulose materials.

48. The process as claimed in claim 46, wherein the particulate or fibrous lignocellulose materials are impregnated with solutions of the flame retardants of the type consisting of boric acids or the salts thereof or both at temperatures of from 20 to 90° C., the impregnated particulate or fibrous lignocellulose materials are dried at from 55 to 170° C., and synergistic agents and melamine resins are mixed as solids with the impregnated particulate or fibrous lignocellulose materials.

49. The process as claimed in claim 46, wherein the particulate or fibrous lignocellulose materials are impregnated with solutions or dispersions of the flame retardants of the type consisting of boric acids or the salts thereof or both and synergistic agents at temperatures of from 20 to 90° C., the impregnated particulate or fibrous lignocellulose materials are dried at from 55 to 170° C., and melamine resins are mixed as solids with the impregnated particulate or fibrous lignocellulose materials.

50. The process as claimed in claim 46, wherein further additives are added to the melamine resins, to the flame retardants of the type consisting of boric acids or the salts thereof or both, or to the synergistic agents.

51. A molding material for the production of flameproofed lignocelluose composites, prepared by the steps of:
a) dry premixing of the components
i—from 40 to 95% by mass of flame-retardant mixture comprising:
from 60 to 90% by mass of at least one of particulate and fibrous lignocellulose materials, and
from 40 to 10% by mass of a flame-retardant concentrate immobilized on or in the particulate or fibrous lignocellulose materials as carriers, having
from 16 to 60% by mass of flame retardants of the type consisting of boric acids or the salts thereof or both, and
from 16 to 75% by mass of melamine resins, the melamine resins being polycondensates partly or completely etherified with C₁-C₁₈-monoalcohols, dialcohols or polyalcohols of melamine and C₁-C₈-aldehydes, and wherein the flame retardants of the type consisting of boric acid or the salts thereof are chemically coupled to the melamine resins, and the flame retardant concentrates are immobilized on or in the carrier substance of the particulate or fibrous lignocellulose materials as carriers,
ii—from 5 to 60% by mass of thermosetting prepolymers selected from the group consisting of phenol resins, urea resins, melamine resins, guanidine resins, cyanamide resins and aniline resins, and
iii—from 0.1 to 10% by mass of processing auxiliaries or auxiliaries,
b) and granulation.

52. The molding material as claimed in claim 51, wherein the preparation is effected by melt compounding at from 100 to 170° C. and granulation following the dry premixing of the components.

53. A flameproofed lignocellulose composite, produced by extrusion, injection molding or pressing of the molding materials as claimed in claim 51 and curing.
